(19) United States
(12) Patent Application Publication
(10) Pub. No.: US 2016/0108261 A1
(43) Pub. Date: Apr. 21, 2016

(54) SYSTEM AND COMPOSITION FOR CREATING THREE-DIMENSIONAL OBJECTS

(71) Applicant: REDWOODVENTURES, LTD., Hong Kong (HK)

(72) Inventors: Andrew Wiseman, Bella Vista, AR (US); Corey Feit, St. Louis, MO (US); Fei Yam, Hong Kong (HK)

(21) Appl. No.: 14/918,512

(22) Filed: Oct. 20, 2015

Related U.S. Application Data
(60) Provisional application No. 62/066,002, filed on Oct. 20, 2014.

(30) Foreign Application Priority Data
Jun. 2, 2015 (US) PCT/US15/33701

(51) Int. Cl. C09D 11/03; B43K 8/14

(52) U.S. Cl. CPC C09D 11/03; B43K 8/146; C08K 3/0008

(57) ABSTRACT

A system and method for creating three-dimensional artwork and objects is shown and described.

### CROSS-REFERENCE TO RELATED APPLICATIONS

This application claims the benefit of PCT application Serial No. PCT/US15/33701, filed Jun. 2, 2015, which claims benefit from U.S. Provisional Application No. 62/066,002, entitled “System and Method for Creating Three-Dimensional Artwork and Objects” filed Oct. 20, 2014. The complete disclosures of said applications are hereby incorporated by reference.

### TECHNICAL FIELD

The present invention relates generally to the field of writing and drawing implements and, more particularly, to an implement and ink for use in creating three-dimensional artwork and objects.

### BACKGROUND ART

Three-dimensional printers utilizing a power source and powder to print objects in a machine are currently available. For instance, U.S. Pat. No. 7,435,368 teaches a three-dimensional printer that utilizes inkjet-type printheads and powder to prototype and print three-dimensional models. Other three-dimensional printing devices are more mobile and utilize a pen-like device that extrudes a heated substance and a power source to provide a material that cools to form the three-dimensional material, much like a glue gun.

However, these devices and methods are bulky or dangerous for use by children. There is a need for a system and device to provide three-dimensional drawing techniques to children without the use of electronic machinery or heated chemicals.

### DISCLOSURE OF INVENTION

The present invention includes a system and device that allows children and adults to create three-dimensional objects and artwork by extruding a fast-drying compound upon a non-stick surface and then removing the dried artwork or object for inclusion in a larger object or piece of artwork.

The present invention includes a fast-drying or fast-setting compound which can be extruded vertically to create three-dimensional objects. The fast-setting compound is cured by lights.

Other aspects of the invention will become apparent by consideration of the detailed description and accompanying drawings.

### BRIEF DESCRIPTION OF THE SEVERAL VIEWS OF THE DRAWINGS

In the following drawings, which form a part of the specification and which are to be construed in conjunction therewith, and in which like reference numerals have been employed throughout wherever possible to indicate like parts in the various views:

FIG. 1 is a perspective view of the pen of the first embodiment of the present invention;

FIG. 2 is a perspective view of the pen and the tablet of the present invention;

FIG. 3 is a right cross-sectional view of the pen of a embodiment of the present invention;

FIG. 4 is right side elevational view of the second embodiment of the present invention;

FIG. 5 is a perspective view of the pen of the third embodiment of the present invention;

FIG. 6 is an exploded view of the same;

FIG. 7 is a front elevational view of the same;

FIG. 8 is a rear elevational view of the same;

FIG. 9 is right side elevational view of the same, with the reservoir removed;

FIG. 10 is a top plan view of the same;

FIG. 11 is a bottom plan view of the same; and

FIG. 12 is perspective view of the pen of the fourth embodiment of the present invention.

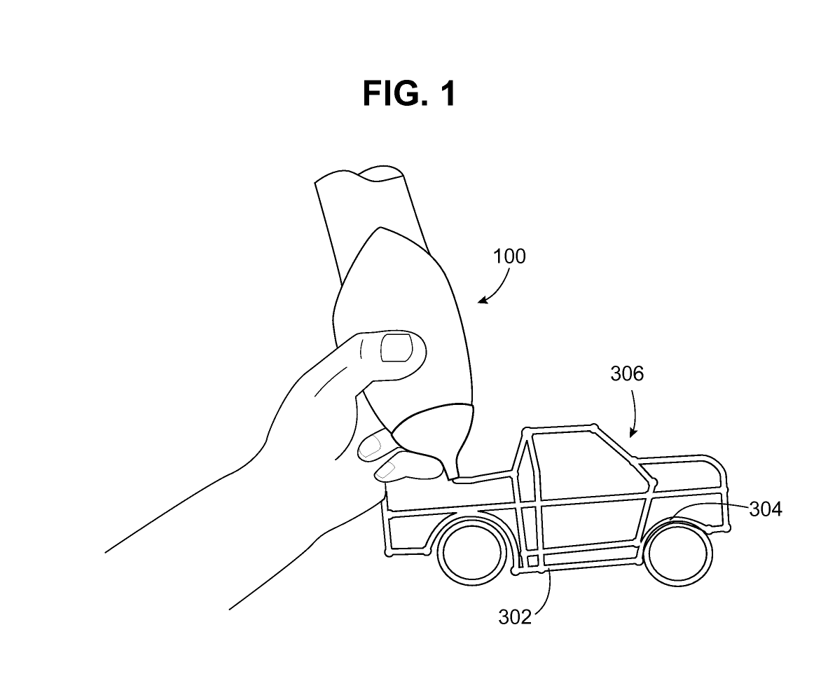

### BEST MODE FOR CARRYING OUT THE INVENTION

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Certain terms are defined below to facilitate understanding of exemplary embodiments for convenience only and is not limiting. To the extent a term used in a claim is not defined below, it should be given the broadest definition persons in the pertinent art have given that term as reflected in printed publications and issued patents.

As used herein, the term “about” when placed before a numerical value “X” refers to an interval extending from X minus 10% of X to X plus 10% of X, preferably to an interval extending from X minus 5% of X to X plus 5% of X, and even more preferably to an interval extending from X minus 2% of X to X plus 2% of X.

The term “beveled” is not used in a limitative sense, since the beveled surface may also be arcuate or conical.

The term “compound”, “composition”, “ingredient” and “component” may sometimes be used interchangeably to refer to one or more chemical components. As used herein, the term “compound” means a mixture composed of two or more separate elements.

The term “ink” is meant to include any pigmented material, including, but not limited to, inks, dyes, paints, or other similarly pigmented liquids.

As used herein, the term “light” means sunlight or artificial light, including ultraviolet light, incandescent light, LED light, or fluorescent light source known in the art.

The term “liquid” when used to describe the ink composition of the invention, is meant to include any non-solid physical state of the composition capable of dispersing or spreading onto a given surface, i.e., in both its highly flowable state as well as semi-solid viscous state.

As used herein, the term “nozzle” covers any conventional or preferred static mechanical device used to direct or modify the flow of a fluid.

As used herein, the term “stylus” includes not just pen shaped devices. Also, the term “pen” and “stylus” are used generically and interchangeably.

As used herein, the term “reservoir” includes a receptacle or chamber for containing a fluid.

Although directional references, such as upper, lower, downward, upward, rearward, bottom, front, rear, etc., may be made herein in describing the drawings, these references are made relative to the drawings (as normally viewed) for convenience. These directions are not intended to be taken literally or limit the present invention in any form. In addition, terms such as “first”, “second”, and “third” are used herein for purposes of description and are not intended to indicate or imply relative importance or significance. The terminology includes the words above specifically mentioned, derivatives thereof and words of similar import.

The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The instant invention provides a pen 100 comprising a compressible reservoir 502 having a proximal end 104, a distal end 106 and a side wall 108 extending from the proximal end 104 to the distal end 106, the reservoir 502 containing a liquid compound 110; a nozzle 112 coupled to the proximal end 104 of the reservoir 502 through which liquid compound exits the reservoir. When the reservoir 502 is squeezed the liquid compound 110 within the reservoir 502 is forced out the nozzle 112. The pen 100 is composed of a thin-walled plastic material that allows for easy compression of the reservoir 502. The nozzle 112 is sufficiently large enough for an amount of compound 110 to be extruded upon a surface. A cap 116 is provided.

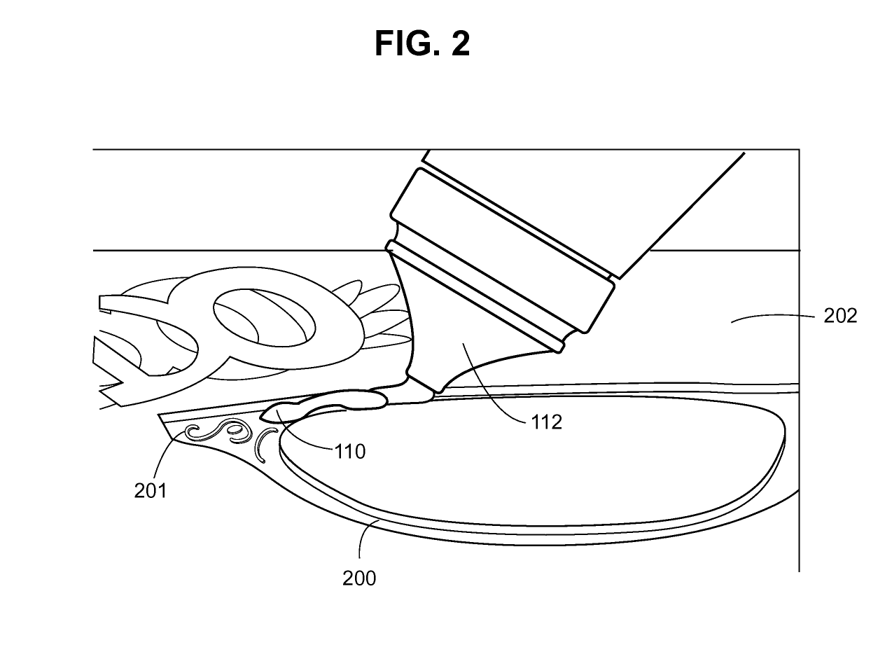

As shown in FIG. 2, the pen 100 is used to impart an ink composition to draw two-dimensional objects on a flat surface or a surface 200 having indentations or recesses 201 to be filled with ink. Preferrably, the surface is a non-stick surface 202 composed of a suitable material, such as silicone or a laminate plastic material with a non-stick coating. The surface 202 is transparent and covers the desired drawing object 204 or provides a recess 201 in the form of the desired drawing object 204. Alternatively, the drawing object 204 is printed into the flat surface 202.

The liquid ink compound 110 is a material that remains in a liquid or gel form within the reservoir 502 and as it extrudes from the nozzle 112. Upon contact with light, the liquid compound 110 begins to harden rapidly and sets into a fibrous material 302. The fibrous material 302 is flexible, but dense enough to retain a shape. As such, upon hardening, it can be removed from the drawing surface 202 and used to create three-dimensional objects, such as the object shown in FIG. 2. The liquid compound 110 may be composed of many different materials that allow for quick-drying upon exposure to light. The liquid compound 110 may include dye materials to allow for variation of colors of the drawn objects.

The two-dimensional object 204 is traced by using the pen 100. As the ink compound 110 is extruded, it dries. Once the compound dries, the ink fibrous material 302 is removed from the drawing surface 202. Other two-dimensional objects, such as the earpiece of glasses, may be joined to the dried fibrous material 302 by providing a joining piece 304 between the pieces of fibrous material. In this manner, a three-dimensional object 306 is created.

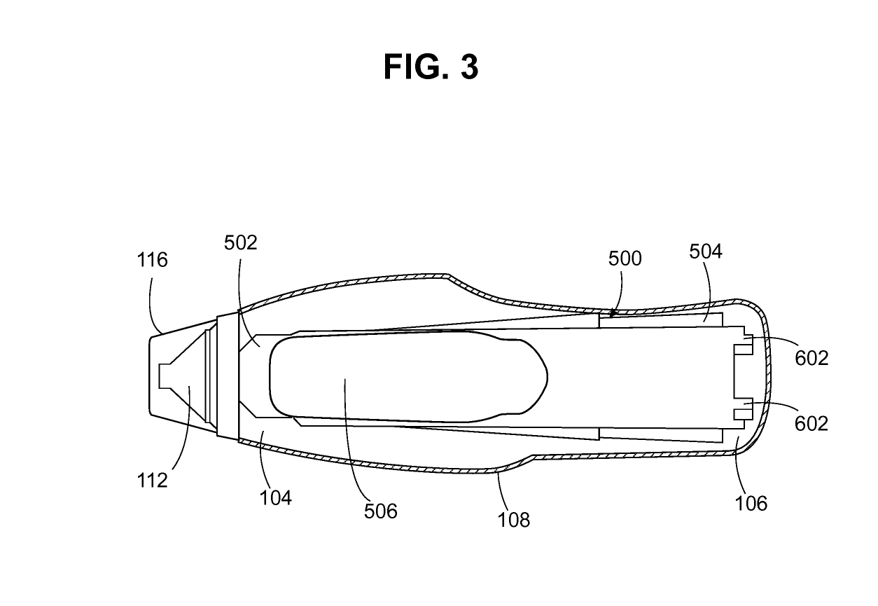

FIG. 3 shows the pen 100 with the interior sections provided in relation to the exterior side wall 108. An interior reservoir 502 is shown within the exterior reservoir to house the compound 110. The interior reservoir 502 is connected to the nozzle 112. The compound 110 housed within the reservoir is biased out of the reservoir 502 through the manual manipulation of a clamping system 500. As pressure is placed on the side wall 108, biasing clamps 504, 506 are pressed into the reservoir 502 on each side of the 502. The clamps 504, 506 are connected pivotally at the distal end of the pen by a pivot connection 602.

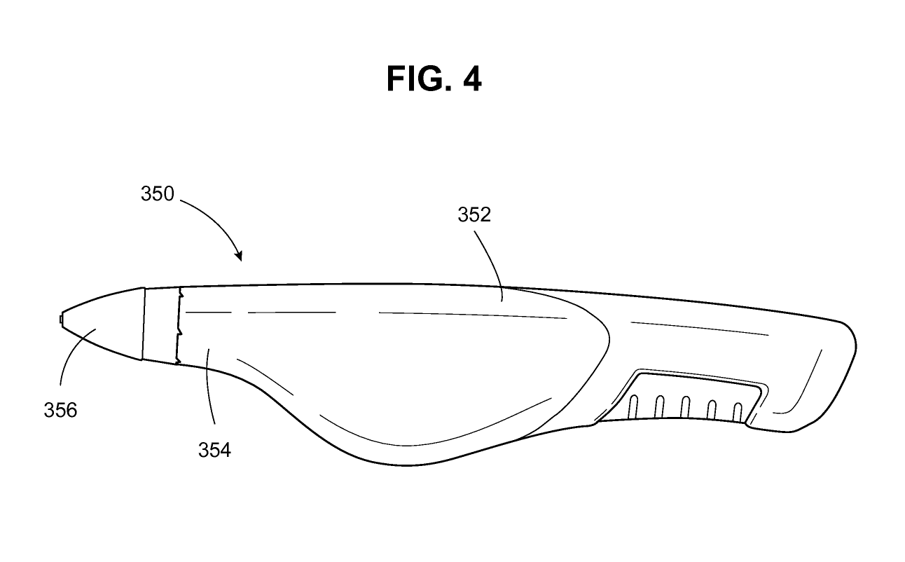

FIG. 4 shows an alternative embodiment of the pen 350 without the clamping system 500 of FIG. 3. The pen 100 is composed of an exterior casing 352 which forms a compressible reservoir 354 for holding the composition 110. Upon manual compression of the casing 352, the reservoir 354 is compressed to extrude the composition 110 from the nozzle 356.

From the foregoing, it should be clear that one can write, print, draw, or color with the pen 100 in a fashion similar to that employed when using an ordinary pen or pencil. The pen is gripped in substantially the same way. The nozzle is moved in substantially the same fashion as the writing tip of a pen or pencil. The only difference is that the user squeezes the pen 100 and together between the forefinger and thumb of the hand to cause and control the flow of liquid compound from the nozzle 112 as the user imparts a writing, printing, drawing or coloring motion to the nozzle.

The ink composition of the invention includes a light curable resin. More specifically, the ink composition of the invention is a mixture comprising an unsaturated prepolymer and a photoinitiator. Additional ingredients which can be used include, but are not limited to, dye and elastomers.

The ink composition utilizes an unsaturated prepolymer or light curable resin. The unsaturated prepolymer or light curable resin can be present in an amount sufficient to afford the composition the curing rate desired. The unsaturated prepolymer is selected from a group consisting of unsaturated polyurethane prepolymers, unsaturated polyacrylate prepolymers, unsaturated epoxy prepolymers or their copolymers in various ratios. The unsaturated prepolymer or light curable resin can be present in an amount ranging from less than 60% to about 85% by weight of the total composition.

The ink composition of the invention includes a photoinitiator selected from the benzoylphosphine oxide class of polymerization photoinitiators. Preferably, the photoinitiator utilized is 2,4,6-trimethylbenzoyl diphenylphosphine oxide. The photoinitiator can be present in an amount ranging from less than 1% to about 10% by weight of the total composition.

A second photoinitiator may be utilized in addition to the benzoylphosphine oxide class photoinitiator. This second photoinitiator is selected from a group consisting of ethyl (4-dimethylamino) benzoate or ethyl (2-dimethylamino) benzoate. The second photoinitiator can be present in an amount ranging from less than 1% to about 5% by weight of the total composition.

A silicon elastomer light dispersing agent may be utilized. The light dispersing agent can be present in an amount ranging from less than 1% to about 5% by weight of the total composition.

Propylene glycol may be included in the composition as a preservative and emulsifier. The emulsifier may be present in an amount ranging from less than 1% to about 10% by weight of the total composition.

A plasticizer may be included in the composition. An acceptable plasticizer may include, but not is not limited to, epoxidized soybean oil. The plasticizer may be present in an amount ranging from less than 1% to about 10% by weight of the total composition.

A thickener may be included in the composition. The thickener may include, but is not limited to, glycerol monostearate. The thickener may be present in an amount ranging from less than 1% to about 5% by weight of the total composition.

A stabilizer may be included in the composition. The stabilizer may include, but is not limited, butylated hydroxy toluene or butylated hydroxy anisole or analogues. The stabilizer may be present in an amount ranging from less than 1% to about 2% by weight of the total composition.

Additional oils and solvents may be included in the composition to adjust the viscosity of the composition in its liquid form.

Dyes which can be used in the invention include, but are not limited to, FD&C Yellow #5 (available from B F Goodrich Hilton Davis Chemical Company, Brecksville, Ohio), FD&C Yellow #6 (available from B F Goodrich Hilton Davis Chemical Company) D&C Yellow #10 (available from Warner Jenkinson, St. Louis, Mo.), FD&C Blue #1 (available from B F Goodrich Hilton Davis Chemical Company), D&C Red #28 (available from Warner Jenkinson), D&C Red #33 (available from Warner Jenkinson), Magenta Dispersion (available from Warner Jenkinson), Green Dispersion (available from Colorcon, West Point, Pa.), and Yellow Dispersion (available from Colorcon).

The dye can be present in an amount sufficient to afford the composition with apparent coloration. The dye can be present in an amount ranging from less than 1% to about 10% by weight of the total composition.

A variety of colors can be used as the dye ingredient of the inventive composition. The liquid fill composition can be colored red, magenta, pink, yellow, blue, orange, purple, violet, green, and the like. Typically, highly visible attractive colors are used, including fluorescent versions of the colors. Color-changing dyes can be used as the dye ingredient as well, including color-changing dyes which react to temperature changes, light changes, and pH changes.

The ink composition may be cured using lights as detailed below or by light from a separate device or the sun.

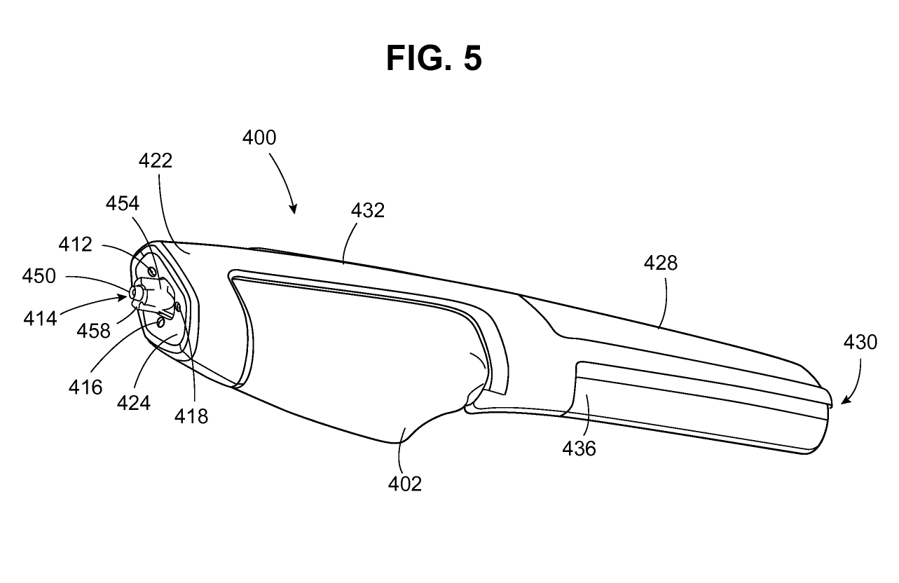

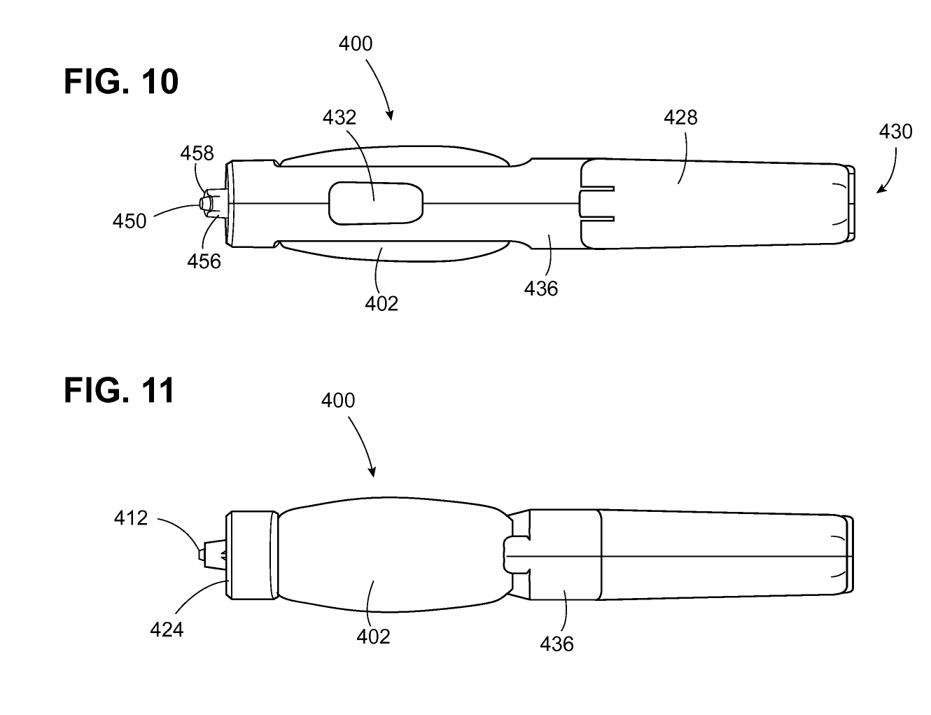

An alternative embodiment of a pen 400 is presented in FIG. 5-11 that utilizes an artificial light array 420 to cure the ink composition extruded from the pen 400. External artificial light can be used to cure the ink composition, such as light from interior lights or from a spotlight. Natural sunlight can also be used. The additional light speeds the curing process.

The pen 400 includes a housing 436 and a removable compressible reservoir 402 having a proximal end 404, a distal end 406 and a side wall 408 extending from the proximal end 404 to the distal end 406, the reservoir 402 containing a liquid compound 110; a nozzle 412 coupled to the proximal end 404 of the reservoir 402 through which liquid compound exits the reservoir. When the reservoir 402 is compressed the liquid compound 110 within the reservoir 402 is forced out the nozzle 412. The compressible reservoir 402 is constructed of a thin-walled plastic that allows manual compression from a human hand. The nozzle 412 is sufficiently large enough for an amount of compound 110 to be extruded upon a surface. As shown, the reservoir 402 is intended for manual compression of the reservoir to extrude the composition from the reservoir. However, it is envisioned that other mechanisms for extrusion are suitable and may be utilized as well. It is envisioned that compression clamps as used with the first embodiment may also be used to compress the reservoir 402 of this embodiment.

As shown in FIG. 5, the pen 400 is an elongated structure that extends along the longitudinal axis of the pen 400 to fit the hand. The light array 420 provides a curing mechanism for the liquid ink within the reservoir after it is extruded. The nozzle 412 is located at the proximal end 414 of the pen 400 proximate the lighting array 420 and is elongated a distance therefrom to allow extrusion from the nozzle.

As will be appreciated by one skilled in the art, the ink composition must be fully extruded from the nozzle prior to curing or the nozzle will become obstructed. As such, the ink composition must be distanced from the nozzle prior to the curing and any curing mechanism must accommodate for this extrusion. The artificial lighting array 420 of the present invention utilizes a structurally significant nozzle in conjunction with light placement to provide a curing mechanism close to the extrusion point without blocking the nozzle opening 438.

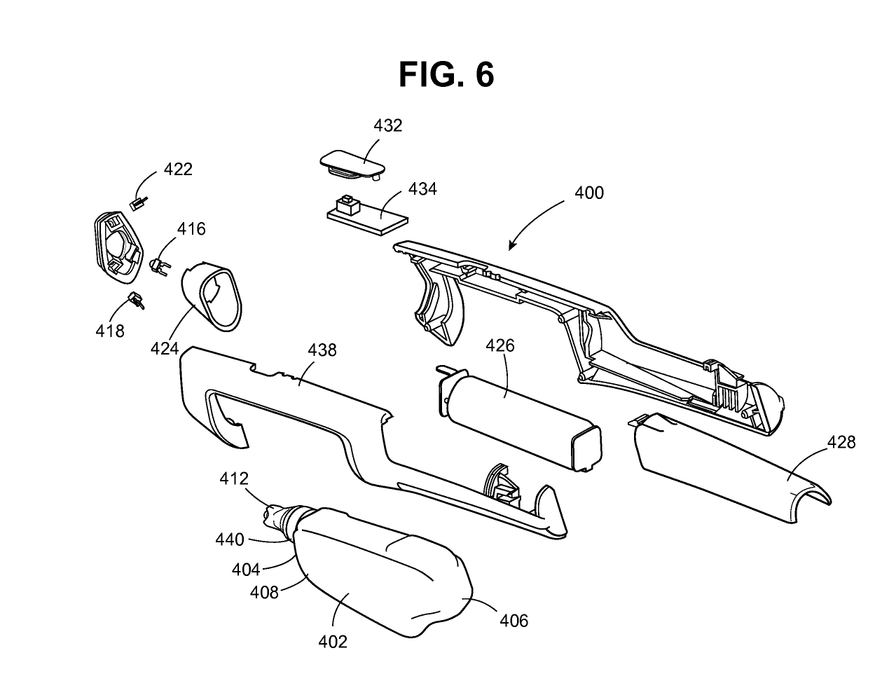

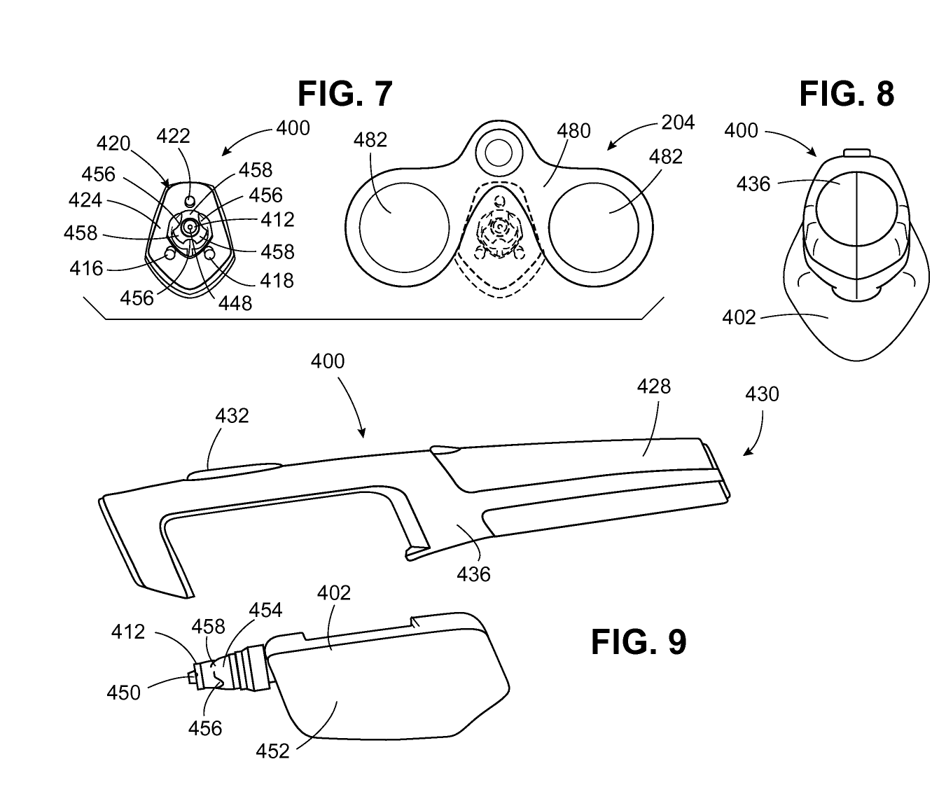

As shown in FIG. 9, the nozzle extends from the body 452 of the reservoir 402. The nozzle includes a circular terminus 450, which includes the extrusion aperture 448, and a beveled nozzle body 454, which extends from the surround 424 of the proximal end 414 of the pen 400. The beveled nozzle portion 454, as shown in FIG. 7, is an arcuate portion having three arcuate or beveled recesses 456 around the circumference of the nozzle portion 454. Between the arcuate recesses 456, three arcuate bridges 458 extend along the circumference of the nozzle portion 454. In conjunction with the light array 420, discussed more fully below, the arcuate bridges 458 produce shadows when used with the light array 420 to limit light exposure to the immediate tip of the nozzle to a distance further removed from the nozzle.

The lighting array 420 includes at least two lights 416, 418 directed at the nozzle 412 to provide a light source to the composition as it is extruded from the nozzle 412. In testing, applicants found that multiple lights assisted in increasing the speed in curing of the ink composition. Additional lights 422 may be provided in the light array as well to provide additional light to the curing extruding composition. The speed of curing the ink composition greatly affects the use of the product. In this manner, the composition can cure and set as it is being extruded. These lights 416, 418, 422 are positioned proximate to the arcuate bridges 458 of the nozzle 454. The lights of the lighting array 420 are directed at an angle towards the tip 450 of the nozzle. The angle of the lights may be between 20 degrees and 60 degrees.

The lighting array 420 is provided in an angular arrangement around the nozzle 412 to effectively direct light towards the tip of the nozzle 412. As shown, the lighting array is positioned with the lights 416, 418, 422 spaced equidistantly around the nozzle. The lights 416, 418, 422 may include any light bulbs known in the art sufficient to provide light to cure the extruded composition. The lights 416, 418, 422 are set within a surround 424 of the proximal end 414 of the pen 400. The surround 424 may be concave and may be smooth or angular and reflective to amplify the light produced by the light elements 416, 418, 422. The surround 424 as shown encircles the nozzle.

A magnifying device 480 suitable for light transmission and magnification, such as a lens, may be attached to the housing 436 of the pen. The magnifying device 480 may be utilized to magnify the light from the environment or from the light array 420 to cure the composition more rapidly. The magnifying device 480 includes at least one lens 482 to magnify the light.

The lighting array 420 has a power source 426 and a control circuit 434. The power source 426 can be batteries stored within the device and replaced through access to a hatch 428 at the distal end 430 of the pen 400. A button 432 controls the operation of the lighting array 420. The control circuit 434 modulates the level of intensity of the light array 420 at a safe level and adequate level to cure the ink composition. The control circuit 434 may include a voltage booster or reducer for the power source 426.

The removable reservoir 402 fits within a recess 438 in the housing 436 at the tip of the housing. The reservoir includes the nozzle 412 as a unitary structure. The nozzle 412 is fitted within a recess of the surround upon placement of the compressible reservoir 402 in the housing 436. The reservoir 402 is a manually compressible reservoir having a proximal end 104, a distal end 106 and a side wall 108 extending from the proximal end 104 to the distal end 106, the reservoir 502 containing a liquid compound 110; a nozzle 450 coupled to the proximal end 104 of the reservoir 402 through which liquid compound exits the reservoir. When the reservoir 402 is squeezed the liquid compound 110 within the reservoir 402 is forced out the nozzle 450. The reservoir is composed of a thin-walled plastic material that allows for easy compression of the reservoir 402. As shown, the reservoir 402 fits within the housing 436 and does not extend along the entire interior space of the housing 436. The extrusion of the compound 110 is effected through the compression of the reservoir 402 which compromises a portion of the length of the housing. As shown, the reservoir extends roughly half of the length of the housing. It is envisioned that compressible reservoir can extend between a quarter to three quarters of the length of the reservoir while still allowing for effective compression and extrusion of the compound 110.

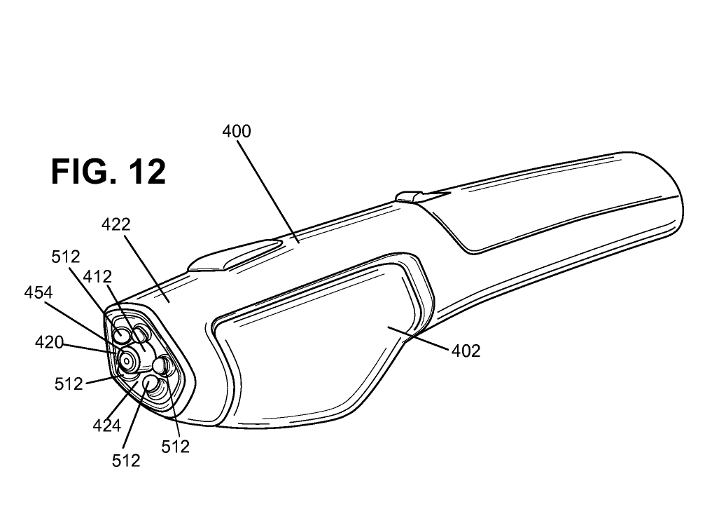

An alternative embodiment of a pen 400 is presented in FIG. 12 that utilizes an alternative artificial light array 420 to cure the ink composition extruded from the pen 400. The light array 420 includes five lights 512 directed at the nozzle 412 and spaced equidistally. The lights 512 are set within a surround 424 of the proximal end 414 of the pen 400. The surround 424 may be concave and may be smooth or angular and reflective to amplify the light produced by the light elements 416, 418, 422. The surround 424 as shown encircles the nozzle.

From the foregoing, it will be seen that this invention well adapted to obtain all the ends and objects herein set forth, together with other advantages which are inherent to the structure. Although the invention has been described in detail, the same is for purposes of illustration only and should not be taken in any way as a limitation on the scope of the invention. As will be readily apparent to those skilled in the art, various other modifications and components are within the scope of the invention.

What is claimed is:

1. The ink composition configured for use in a drawing instrument or three-dimensional printer, said ink composition comprising:
an unsaturated prepolymer;
a photoinitiator selected from the group consisting of benzoylphosphine oxide class of polymerization photoinitiators; and
a dye.

2. The ink composition according to claim 1 wherein said unsaturated prepolymer is present in an amount ranging from about 60% to about 85% by weight of the total composition.

3. The ink composition according to claim 1 further comprising a second photoinitiator selected from the group consisting of ethyl (4-dimethylamino) benzoate and ethyl (2-dimethylamino) benzoate.

4. The ink composition according to claim 1 further comprising an emulsifier.

5. The ink composition according to claim 1 further comprising a light dispersing agent.

6. The ink composition according to claim 1 further comprising an stabilizer selected from the group consisting of butylated hydroxy toluene, butylated hydroxy anisole, analogues of butylated hydroxy toluene, and analogues of butylated hydroxy anisole.

7. The ink composition of according to claim 2 further comprising:
a second photoinitiator selected from the group consisting of thyl (4-dimethylamino) benzoate and ethyl (2-dimethylamino) benzoate;
a light dispersing agent; and
a stabilizer selected from the group consisting of butylated hydroxy toluene, butylated hydroxy anisole, analogues of butylated hydroxy toluene, and analogues of butylated hydroxy anisole.

8. A drawing device comprising:
a housing having a compressible reservoir for containing an ink composition;
a nozzle configured to extrude said ink composition from said compressible reservoir;
said ink composition further comprising a light curable resin.

9. The drawing device according to claim 8, further comprising a power source and a light array proximate said nozzle, said light array having at least one light configured to illuminate ink composition extruded from said nozzle.

10. The drawing device according to claim 8, said ink composition comprising:
a photoinitiator selected from the group consisting of benzoylphosphine oxide class of polymerization photoinitiators; and
a dye.

11. The drawing device according to claim 10, said ink composition further comprising:
a second photoinitiator selected from the group consisting of thyl (4-dimethylamino) benzoate and ethyl (2-dimethylamino) benzoate;
a light dispersing agent; and
a stabilizer selected from the group consisting of butylated hydroxy toluene, butylated hydroxy anisole, analogues of butylated hydroxy toluene, and analogues of butylated hydroxy anisole.

12. The drawing device according to claim 9, said light array further comprising at least two lights positioned around said nozzle.

13. The drawing device according to claim 8 further comprising a concave surround proximate said nozzle.

14. The drawing device according to claim 8 further comprising a magnifying device.

15. A drawing device comprising:
a housing containing a power source and configured to receive a compressible reservoir for containing an ink composition, said compressible reservoir further comprising a nozzle configured to extrude said ink composition from said compressible reservoir; and
a light array having at least two lights configured to receive power from said power source and located proximate said nozzle in an angular arrangement with said nozzle, said at least two lights configured to illuminate ink composition extruded from said nozzle.

16. The drawing device according to claim 15, said ink composition comprising:
an unsaturated prepolymer;
a photoinitiator selected from the group consisting of benzoylphosphine oxide class of polymerization photoinitiators; and
a dye.

17. The drawing device according to claim 16, said ink composition further comprising:
a second photoinitiator selected from the group consisting of thyl (4-dimethylamino) benzoate and ethyl (2-dimethylamino) benzoate;
a light dispersing agent; and
a stabilizer selected from the group consisting of butylated hydroxy toluene, butylated hydroxy anisole, analogues of butylated hydroxy toluene, and analogues of butylated hydroxy anisole.

18. The drawing device according to claim 15 further comprising a magnifying device.
